(19) United States
(12) Patent Application Publication
(10) Pub. No.: US 2011/0276418 A1
(43) Pub. Date: Nov. 10, 2011

(54) Apparatus, System and Method For Purchaser to Business Payments

(75) Inventor: Malik M. Velani, Carrollton, TX (US)

(73) Assignee: S1 CORPORATION, Norcross, GA (US)

(21) Appl. No.: 13/103,052

(22) Filed: May 7, 2011

Related U.S. Application Data
(60) Provisional application No. 61/332,570, filed on May 7, 2010.

(51) Int. Cl. G06Q 20/00; G06Q 30/00

(52) U.S. Cl. 705/16; 705/26.41

(57) ABSTRACT

A mobile device, a system and method for enabling payment absent communication of payment account information or personal information at a point of sale are disclosed. The purchaser or holder of the payment account is pre-registered with a payment processing system. The purchaser's identity is authenticated and payment account information is communicated only during the pre-registration process. Thereafter, the purchaser uses their mobile device to authorize the payment transaction. The remote payment processing system directs the transfer of funds equivalent to a total purchase price from a first bank supporting the purchaser's payment account to a second bank having a merchant's account. Upon completion of the transfer or instruction, the remote payment processing system sends a confirmation to the merchant and to the purchaser via the mobile device.

### BACKGROUND

Currently, there are various payment methods for consumers to use when purchasing goods and services. For example, FIG. 1 illustrates a payment method often used for making payments by a payment card, such as a credit or debit card. The payment card 22 is presented by a potential customer 20 at a point of sale 10. The payment card 22 includes a region 24 that is encoded with account specific information. For example, credit or debit cards are known to have magnetic strips and/or integrated circuits that store account specific information. During a checkout process, the payment card 22 is scanned by a reader 40, which reads the account specific information from the payment card 22. This scanning operation can be performed by the potential customer 20 at a self-service kiosk (not shown) associated with the reader 40 or by an employee 30 of the service provider. In some embodiments, the payment card 22 is associated with a personal identification number (PIN) that is communicated via the mail with the potential customer 20 (e.g., the owner or holder of the payment card 22). In an effort to confirm that the potential customer 20 is an authorized holder/user of the payment card 22, the potential customer 20 is sometimes asked to use a data entry device 35 to communicate the PIN at the point of sale 10. If the communicated PIN matches the PIN that is associated with the payment card 22, as verified by the clearing house 50 or the reader 40, the account information and purchase transaction details are communicated to the clearing house 50. In turn, the clearing house 50 settles both the potential customer's and the service provider's accounts by transferring the purchase amount, and any tax to be collected from that transaction, from the customer's bank 60 to the service provider's bank 70.

There are several drawbacks to this method of payment. One drawback is that the payment card 22 often is handled by an employee 30 of the service provider. Consequently, there is some risk that the employee 30 of the service provider obtains the account number, the customer's name, the expiration date, and a card security code from the customer's payment card 22. For payment cards and or systems that use a PIN to verify the authenticity of the presenter of the payment card 22, there is at least some risk that the customer's PIN is revealed to one or more employees of the service provider and or other passersby at the point of sale 10. Furthermore, entry of a PIN via a data entry device 35 makes it possible for the PIN to be videographically or electronically recorded.

A second drawback associated with the use of payment cards 22 is that account information is entered and or scanned electronically into an electronic point of sale system. There is some risk that the reader 40 has been modified to permit card information cloning. In addition, once the payment card information has been entered or scanned into a service provider's system, the account information from the payment card 22 can remain in the service provider's electronic systems for an undetermined time. While there is at least some convenience associated with repeat transactions with the merchant, there is additional risk that stored account specific information is later copied, used or sold.

Understanding these inherent risks, the payment card industry has promulgated a set of standards for all merchants that receive, communicate, and store payment card information. Payment card industry (PCI) compliance is a complex and ever evolving subject affecting millions of businesses, including banks, independent sales organizations, processors, hosts, e-commerce and retail merchants and other service providers.

### SUMMARY

Various embodiments of an apparatus, a system, methods, and computer programs, etc. for enabling payment transactions absent the transfer of payment account information at a point of sale are provided. One embodiment is a method for processing a payment between a registered purchaser with a pre-configured mobile device and a merchant or retailer. The method includes the steps of receiving merchant and transaction information at a point of sale on the pre-configured mobile device, and communicating the merchant and transaction information from the pre-configured mobile device to a remote payment processing system, the remote payment processing system having previously authenticated the identity of the purchaser and associated an identifier associated with the purchaser's mobile device with a payment account, wherein the act of communicating the merchant and transaction information from the pre-configured mobile device authorizes the remote payment processing system to issue an instruction to one or more appropriate networks, financial institutions or alternative payment providers to transfer a total purchase price from a first bank supporting the payment account to a second bank having a merchant's account.

Another embodiment is a method for conducting a sale of goods or services to a pre-registered purchaser with a pre-configured mobile device. The method includes the steps of communicating merchant and transaction information at a point of sale to the pre-configured mobile device and receiving confirmation of payment from a remote payment processing system, the remote payment processing system having received the merchant and transaction information, the remote payment processing system having previously authenticated the identity of the purchaser and associated an identifier associated with the purchaser's mobile device with a payment account, wherein a communication from the pre-configured mobile device authorizes the remote payment processing system to send an instruction directing the transfer of a total purchase price from a first bank supporting the payment account to a second bank having a merchant's account.

A third embodiment is a method for processing a payment between a payment account holder's bank and a merchant's bank. The method includes in a registration process, collecting a purchaser's identification information, payment account information and at least one mobile device specific identifier, and authenticating the identity of the purchaser, receiving merchant and transaction information, wherein receipt of a substantially concurrent message from the mobile device directs the remote payment processing system to initiate and communicate an instruction to transfer a total purchase price from the payment account holder's bank to a merchant's account with the merchant's bank and communicating confirmation of the communication of the instruction to the merchant.

A fourth embodiment is a method for processing a payment between a registered purchaser with a pre-configured mobile device and a merchant. The method includes receiving token information with merchant and transaction information at a remote payment processing system, the transaction information identifying a total purchase price, verifying that the token information identifies the registered purchaser, retrieving stored payment account information associated with the registered purchaser and directing the transfer of funds in the amount of the total purchase price from a first bank supporting the payment account to a second bank having a merchant's account.

A fifth embodiment is a method for conducting a sale of goods or services to a pre-registered purchaser with a pre-configured mobile device. The method includes receiving token information at a point of sale from the pre-configured mobile device, communicating the token information with merchant and transaction information from the point of sale to a remote payment processing system and receiving confirmation of a directed transfer of funds in the amount of a total purchase price from a first bank supporting a payment account to a second bank having a merchant's account from the remote payment processing system, the remote payment processing system having previously authenticated the identity of the pre-registered purchaser and associated the pre-registered purchaser with the payment account.

An example apparatus or device includes a mechanism for capturing merchant and transaction information at a point of sale and a transmitter for communicating the merchant and transaction information from the mobile device to a remote payment processing system, the remote payment processing system having previously authenticated the identity of the purchaser and associated an identifier associated with an identified mobile device with a payment account, wherein the act of communicating the merchant and transaction information from the mobile device authorizes the remote payment processing system to generate and communicate an instruction that transfers a total purchase price from a first bank supporting the payment account to a second bank having a merchant's account.

An exemplary system includes a network interface, a memory and a processor. The network interface receives payment account and personal information from a holder of a payment card. The personal information includes a mobile device specific identifier. The network interface later receives merchant and transaction information from a mobile device associated with the mobile device specific identifier. The memory, which is in communication with the network interface, stores the mobile device specific identifier, the payment account and personal information from the holder of the payment card, executable authentication logic, and executable payment logic. The processor, which is in communication with both the network interface and the memory, executes the authentication logic to authenticate the identity of the holder before enabling the executable payment logic. Later, when the holder of the payment account desires to make a payment for goods or services, the holder uses their mobile device to remotely direct the processor to execute the payment logic.

Other apparatuses, systems, methods, features, and advantages of the purchaser to merchant payments will be or become apparent to one with skill in the art upon examination of the following figures and detailed description. All such additional apparatuses, systems, methods, features, and advantages are within the scope of the purchaser to merchant payments and are protected by the accompanying claims.

### BRIEF DESCRIPTION OF THE DRAWINGS

The apparatus, system, and methods for purchaser to merchant payments can be better understood with reference to the following figures. The components within the figures are not necessarily to scale, emphasis instead being placed upon clearly illustrating the principles involved. Moreover, in the figures, like reference numerals designate corresponding parts throughout the different views.

FIG. 1 is a functional block diagram of a prior art payment transaction.

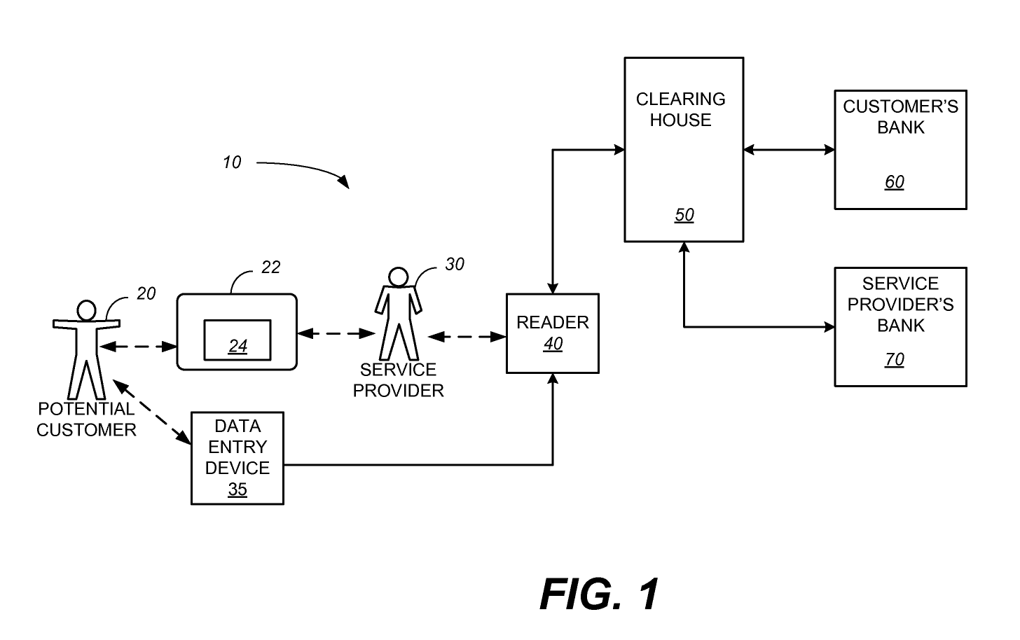

FIG. 2A is a functional block diagram illustrating an embodiment of a purchaser to merchant payment where no payment card information is communicated at the point of sale.

FIG. 2B is a functional block diagram illustrating an alternative embodiment of a purchaser to merchant payment where a unique token is communicated from a pre-configured mobile device to a merchant.

FIG. 3A is a flow diagram illustrating an embodiment of a method for processing a payment between a registered purchaser with a pre-configured mobile device and a merchant.

FIG. 3B is a flow diagram illustrating an alternative embodiment of a method for processing a payment between a registered purchaser with a pre-configured mobile device and a merchant.

FIG. 4A is a flow diagram illustrating an embodiment of a method for conducting a sale of goods or services to a pre-registered purchaser with a pre-configured mobile device.

FIG. 4B is a flow diagram illustrating an alternative embodiment of a method for conducting a sale of goods or services to a pre-registered purchaser with a pre-configured mobile device.

FIG. 5 is a flow diagram illustrating an embodiment of a method for processing a payment between a payment account holder's bank and a merchant's bank.

FIG. 6 is a functional block diagram of the mobile device of FIG. 2.

FIG. 7 is a functional block diagram of the remote payment processing system of FIG. 2.

### DETAILED DESCRIPTION

A mobile device, a system and methods for enabling payment absent communication of payment account information or personal information at a point of sale are invented and disclosed.

A purchaser and holder of a payment account pre-registers with a retailer. During the pre-registration process, the payment account holder's identity is authenticated and information is communicated from the payment account holder to the retailer. The information may be communicated in person, on the telephone, using a secure web page accessible on the Internet, or by completing a request form and returning a signed copy of the same via the mail to the retailer. In addition to sharing personal information and payment account information with the retailer, as will be described in greater detail below, the registration process further includes configuring the payment account holder's mobile device.

The retailer can selectively accept information associated with multiple payment accounts from the holder. For example, the retailer can accept information that identifies a customer's payment account with the retailer, as well as, one or more payment accounts sponsored by VISA®, MasterCard®, American Express®, etc. The retailer may also accept the customer's account information with one or more banks, savings and loans, or credit unions. By way of further example, the retailer may also accept customer account information with one or more third-party remote payment processing system s such as PayPal®, BillMeLater®, Moneta®, etc. VISA® is the registered trademark of Visa International Service Association of Foster City, Calif., U.S.A. MasterCard® is the registered trademark of Mastercard International Incorporated of Purchase, N.Y., U.S.A. American Express® is the registered trademark of American Express Marketing & Development Corp., New York, N.Y., U.S.A. PayPal® is the registered trademark of Paypal, Inc. of San Jose, Calif., U.S.A. BillMeLater® is the registered trademark of GoPin, Inc. of Towson, Md., U.S.A. Moneta® is the registered trademark of Subex Limited of Sezii, Karnataka, India.

In conjunction with the receipt of the payment account holder's personal information and payment account information, the retailer provides a mobile device application to the customer for installation on the customer's mobile device. The mobile device application may be made available for download from a webpage accessible on the Internet or may be communicated to the customer as an attachment to an electronic mail message. The mobile device application includes executable instructions for registering or associating the customer's mobile device with the retailer's payment service. The mobile device application further includes executable instructions for initiating and completing purchase transactions without communicating personal information and payment account information at a point-of-sale.

The registration of the customer's mobile device may include prompting the customer to enter a personal identifier, a passcode, or to answer a question with the same response that was previously shared with the retailer. The mobile device application communicates the customer entered information in a short-message service (SMS) message, a multi-media message (MMS) service message, or a phone call to the retailer. The above-described registration process is illustrated in the diagram titled “Registration process,” which appears after the numbered figures.

After the retailer has associated the customer's personal information, payment account information, mobile device information and any additional purchase transaction authorization code, the customer can shop at various retailer locations and initiate payment transfers from their mobile device without communicating personal information or payment account information at the point of sale.

A purchase transaction at a retailer location can be completed by using a pre-registered customer's mobile device to communicate merchant and transaction information to a remote payment processing system. The remote payment processing system can be operated exclusively by the retailer. Alternatively, the remote payment processing system and the underlying software and can be provided as a service by another party. The merchant and transaction information can be communicated directly from the merchant's point-of-sale device to the remote transaction processing system or indirectly via the customer's mobile device by way of a two-dimensional bar code. The encoded merchant and transaction information in the two-dimensional bar code can be photographically captured and forwarded from the user's mobile device when it is equipped with a suitable camera. Information can be communicated between the merchant point-of-sale device and a remote payment processing system over wired or wireless data networks. Information can be communicated between the customer's mobile device and the remote transaction processing system via the above-described mechanisms (e.g., SMS, MMS, and email) over a wireless data network and/or a combination of wireless and wired data networks. A point-of-sale purchase transaction process where merchant and transaction information are communicated in an encoded two-dimensional bar code from a point-of-sale device to a customer's mobile device and forwarded to a remote transaction processing system by application software operating on the mobile device is illustrated in the diagram titled “Buying process-bar code,” which appears after the numbered figures.

In accordance with the insert in the above-referenced diagram, the party presenting the mobile device at the point-of-sale can be authenticated as the owner of the mobile device and a holder or authorized user of the payment account previously registered with the remote transaction processing system in various ways. For example, the mobile device application software may prompt the operator to enter a user identifier and/or a password to start the application or before communicating with the remote transaction processing system. Such prompts, if answered correctly, will generally suffice to prevent the initiation of unauthorized payments from the mobile device. When additional authentication is desired, either one or both of the user identifier and the password may be communicated to the remote transaction processing system with the merchant and transaction information. Upon receipt of one or both of the user identifier and the password the remote transaction processing system can verify that the entered information matches the phone number or other unique mobile device identifier associated with the customer's information during the registration process. By way of further example, the mobile device may receive a query from the remote transaction processing system. Failure to enter an appropriate pre-registered response to the query could initiate a secondary query that must be responded to appropriately for the remote transaction processing system to communicate payment instructions.

In an alternative purchasing process, illustrated in the diagram titled “Buying process—SMS message,” a pre-registered customer goes to a retailer location, selects items for sale from the shelves or racks and presents the items at a self-checkout or assisted-checkout station. At the checkout station, the customer communicates the intention to initiate payment for the goods using a mobile phone number. The select payment option can be entered or otherwise communicated by an employee of the retailer or the payment option can be selected by the customer via a payment menu at a point-of-sale device. Thereafter, the point-of-sale device prompts the customer to enter their mobile phone number and the retailer communicates the merchant and transaction information along with the mobile phone number to the remote transaction processing system. The remote transaction processing system receives the transaction request from the retailer and communicates a first SMS message to the mobile phone. The first SMS message includes a merchant identifier/location and a total purchase amount. The customer accepts the purchase transaction request by responding with a second SMS message from the mobile phone to the remote transaction processing system. To authenticate the identity of the customer, the first SMS message may include a prompt for the customer to enter a pre-registered personal identifier, passcode or purchase authorization code in the body of the second SMS message. Alternatively, the customer accepts or authorizes the purchase payment by simply sending a return SMS with the pre-registered personal identifier, passcode or purchase authorization code.

Upon receipt of a purchase transaction request and authentication of the identity of the pre-registered customer, the remote payment processing system forwards the transaction information to an appropriate credit card network, institution, or alternative payment service and communicates a message to the retailer's point-of-sale device and the customer's mobile device indicating that the payment transaction has been approved or denied. Upon receipt of an approval message, the retailer may print a receipt for the customer before releasing the purchased items to the customer. Upon receipt of properly formatted transaction information, the appropriate credit card network, financial institution, or alternative payment service debits the customer's pre-registered payment account and credits a retailer account or bills the customer.

Example purchase transactions are illustrated in the diagrams titled “Transaction flow,” “Transaction flow (alt.),” and “Transaction flow—SMS.” The diagrams share the same general arrangement with a retail point-of-sale device such as a cash register at the far left of the diagrams, a remote payment processing system (labeled Switch and represented by a glass paneled structure) in the upper center portion of the diagrams, a customer with a mobile device is depicted in the lower center portion of the diagrams and credit card networks, financial institutions, and alternative payment provider s shown at the far right of the diagrams. All three transaction processes begin with a retail point-of-sale device presenting a customer with the option of making a “mobile” payment and the customer electing to make the “mobile” payment.

In the diagram titled “Transaction flow,” the point-of-sale device sends merchant, terminal and transaction information such as item identifiers, quantities, price, tax rates and one or more merchant account identifiers to the remote transaction processing system or switch. In return, the switch generates a two-dimensional bar code encoding the received merchant and transaction information and communicates the same to the point-of sale device. Next, the point-of-sale device presents the two-dimensional bar code to the customer. As described above, the presentation can be made via paper or other medium or by way of a display. The customer initiates a previously installed application on their mobile device. The application software prompts the operator to enter one or both of a user identifier and a passcode. The application can authenticate the operator by identifying a match with a pre-registered user identifier and/or passcode entered during the mobile device registration process. Alternatively, the user identifier and/or passcode can be communicated to the remote transaction processing system or switch and compared with the user identifier and/or passcode stored as a result of the registration process.

Upon successful completion of the authentication process, the customer uses their mobile device to capture the two-dimensional code and communicate the same to the remote transaction processing system or switch. The communication includes the encoded merchant and transaction information as well as a mobile-device identifier. When the customer has pre-registered multiple payment accounts, the application software on the mobile device may include an automatic prompt for the customer to identify a select account for payment. When this is the case, the communication to the remote transaction processing system or switch will include a code or payment account identifier. Alternatively, the application software on the mobile device may be programmed to use a default account. Upon verification that the mobile-device identifier is associated with a registered user, the remote transaction processing system or switch decodes the merchant and transaction information and generates a payment instruction using the default payment account or the select payment account identified by the customer. Once the payment instruction has been communicated to the appropriate card network, financial institution or alternative payment service, the remote transaction processing system or switch communicates an approval message to the point-of-sale device and to the customer's mobile device. If the remote transaction processing system or switch is unable to generate an appropriate payment instruction, a transaction declined or error message is communicated to both the point-of-sale device and to the customer's mobile device. As further indicated on the diagram, the appropriate credit card network, financial institution or alternative payment service debits the identified customer account and credits the merchant account in accordance with their respective standard operations or bills the customer. It should be understood that appropriate payment instructions for financial institutions may be aggregated and periodically communicated in a batch process.

In the diagram titled “Transaction flow (alt.),” the point-of-sale device sends merchant, terminal and transaction information such as item identifiers, quantities, price, tax rates and one or more merchant account identifiers to the remote transaction processing system or switch. In return, the switch generates a two-dimensional bar code encoding the received merchant and transaction information and communicates the same to the point-of sale device. Substantially simultaneously with the merchant communications with the remote transaction processing system or switch, the customer starts application software on their mobile device. The application software prompts the customer to enter a valid user identifier and passcode. The user identifier and passcode can be authenticated solely by the application software, the remote transaction processing system or both. Next, the point-of-sale device presents the two-dimensional bar code to the customer. As described above, the presentation can be made via paper or other medium or by way of a display.

Upon successful completion of the authentication process, the customer uses their mobile device to capture (e.g., photograph) the two-dimensional code and communicate the same to the remote transaction processing system or switch. The communication includes the encoded merchant and transaction information as well as a mobile-device identifier. When the customer has pre-registered multiple payment accounts, the application software on the mobile device may include an automatic prompt for the customer to identify a select account for payment. When this is the case, the communication to the remote transaction processing system or switch will include a code or payment account identifier. Alternatively, the application software on the mobile device may be programmed to use a default account. Upon verification that the mobile-device identifier is associated with a registered user, the remote transaction processing system or switch decodes the merchant and transaction information and generates a payment instruction using the default payment account or the select payment account identified by the customer. Once the payment instruction has been communicated to the appropriate card network, financial institution or alternative payment service, the remote transaction processing system or switch communicates an approval message to the point-of-sale device and to the customer's mobile device. If the remote transaction processing system or switch is unable to generate an appropriate payment instruction, a transaction declined or error message is communicated to both the point-of-sale device and to the customer's mobile device. As further indicated on the diagram, the appropriate credit card network, financial institution or alternative payment service debits the identified customer account and credits the merchant account in accordance with their respective standard operations or bills the customer. It should be understood that appropriate payment instructions for financial institutions may be aggregated and periodically communicated in a batch process.

In the diagram titled “Transaction flow—SMS” the point-of-sale device prompts the customer to enter a mobile phone number using the point-of-sale device. In response, the point-of-sale device sends the mobile phone number, a total purchase price, merchant identifiers to the remote transaction processing system or switch. The switch generates a SMS message including the retail location and a purchase amount and communicates the same to the mobile phone number entered by the customer. The customer's identity is authenticated and authorization to proceed is communicated by a return SMS message that includes a pre-registered user identifier, passcode or payment authorization code. Upon receipt of the return SMS message and verification that the message includes the pre-registered user identifier, passcode or payment authorization code, the remote transaction processing system generates a payment instruction using a default payment account or a select payment account identified by the customer. Once the payment instruction has been communicated to the appropriate card network, financial institution or alternative payment service, the remote transaction processing system or switch communicates an approval message to the point-of-sale device and to the customer's mobile device. If the remote transaction processing system or switch is unable to generate an appropriate payment instruction, a transaction declined or error message is communicated to both the point-of-sale device and to the customer's mobile device. As further indicated on the diagram, the appropriate credit card network, financial institution or alternative payment service debits the identified customer account and credits the merchant account in accordance with their respective standard operations or bills the customer. Appropriate payment instructions for financial institutions may be aggregated and periodically communicated in a batch process.

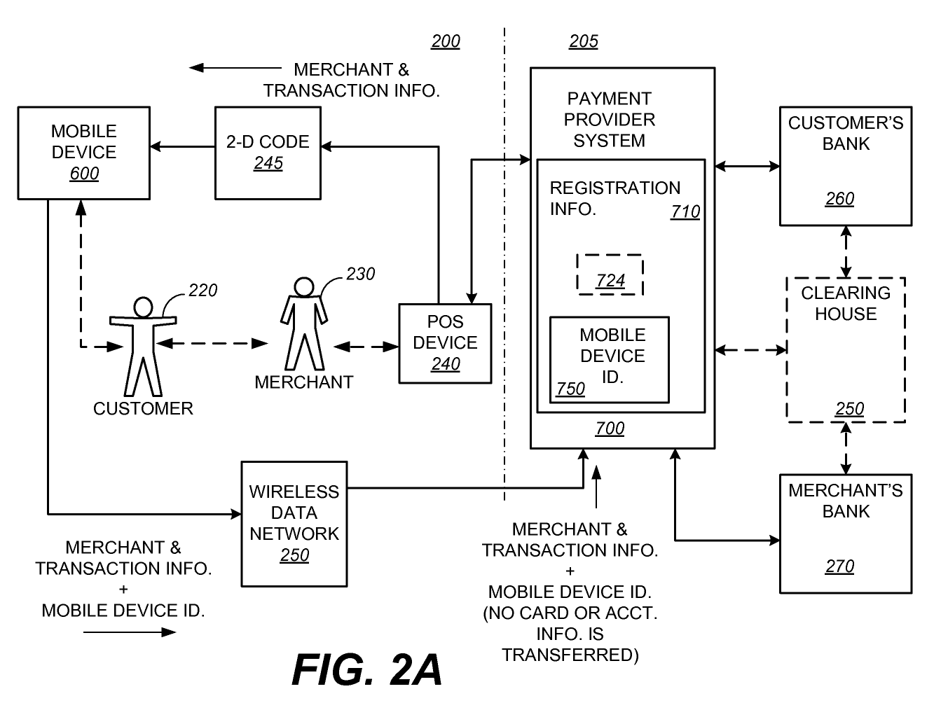

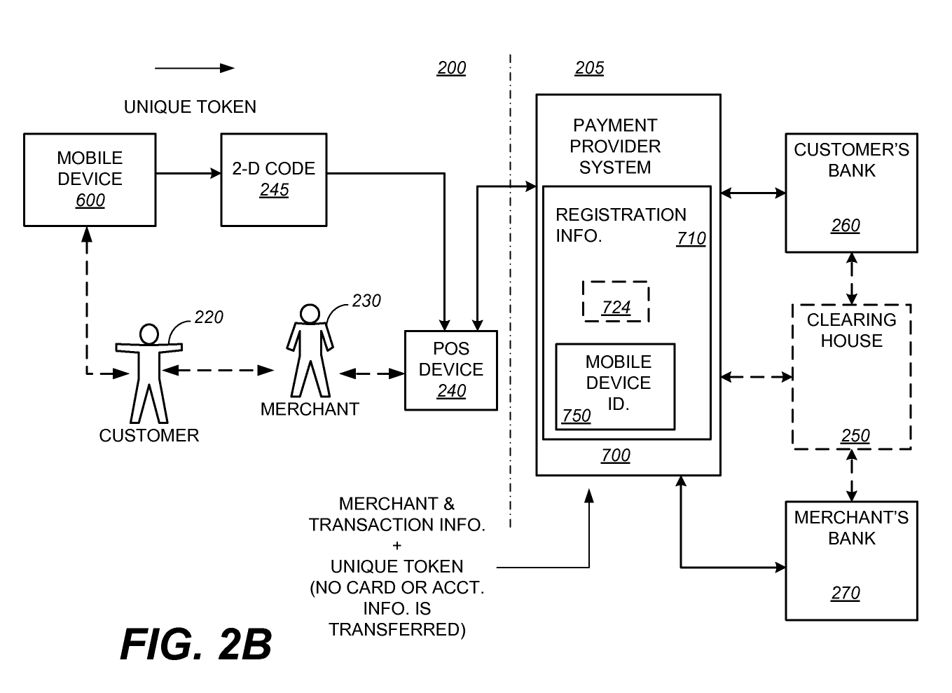

Various embodiments of mobile devices, remote payment processing systems, payment methods, computer programs, etc. for enabling payment at a point of sale absent the communication of payment account or personal information are provided. Several embodiments are described below with reference to FIGS. 2A-7.

FIG. 2A is a functional block diagram illustrating an embodiment of a purchaser to merchant payment where merchant and transaction information are forwarded to a remote payment processing system or payment provider system along with the mobile device identifier. The payment account specific information 724, personal information and the mobile device identifier 750 are communicated to the payment provider system 700 during a registration process, and stored in registration information 710 within a memory device associated with the payment provider system 700. As a result, no payment account specific information 724 or personal information of any kind need be transferred, shared or otherwise communicated at a point of sale. The payment provider system 700 is a hardware device such as a server computer that is accessible via one or data networks. The payment provider system 700 can be operated by the retailer or by a third-party service provider.

A purchaser to merchant payment is illustrated with a point of sale 200 and a payment network 205 separated from one another by various data networks shown as a dashed line. A pre-registered customer 220, i.e., an individual with a payment account that has been registered with the payment provider system 700 interacts with a merchant/retailer 230 or with a point of sale device 240 to identify a good or service that the customer 220 would like to purchase. The point of sale device 240 presents merchant and transaction information to the customer's mobile device 600. The merchant and transaction information includes a merchant identifier, location, date, time, a description of the goods or services that the customer 220 would like to make payment for as well as tax or additional information about the merchant and the transaction. Alternatively, the merchant information may include a retail location identifier and a merchant account where payment is to be accepted. In this alternative embodiment, the transaction information may include a predetermined total amount to be transferred.

As shown in FIG. 2A, the merchant and transaction information may be presented or communicated to the customer's mobile device 600 in the form of a two-dimensional code 245. The two-dimensional code 245 is a keyless data entry or encoding technique that permits the point of service device 240 to communicate or present a portable database of information such as the merchant and transaction information in a graph that is communicated to the mobile device 600. In an example embodiment, the two-dimensional code 245 is communicated to the mobile device 600 using a wireless short range communication protocol commonly known as Bluetooth. In an alternative embodiment, the two-dimensional code 245 is displayed on a monitor and or printed on a sales slip by the point of sale device 240 and photographed by a camera in the mobile device 600.

Thereafter, application software configured on the mobile device 600 directs the mobile device 600 to forward the merchant and transaction information along with the mobile device identifier over the wireless data network 250 from the mobile device 600 to the payment provider system 700. In an example embodiment, the encoded merchant and transaction information is decoded or otherwise interpreted in the mobile device 600. The mobile device 600 communicates the decoded merchant and transaction information along with the mobile device specific identifier using a wireless data communication protocol over the wireless network 250 to the payment provider system 700. In an alternative embodiment, the mobile device 600 simply forwards the two-dimensional code 245 including the merchant information and the transaction information in their encoded form to the payment provider system 700.

Upon receipt of the communication from the mobile device 600 including the mobile device specific identifier, the payment provider system 700, searches previously stored registration information 710 for a matching mobile device identifier 750. The receipt of the merchant and transaction information from the mobile device authorizes the payment provider system 700 to generate an instruction that directs the transfer of a total purchase price from a first bank supporting the payment account (e.g., the customer's bank 260) to a second bank having a merchant's account (e.g., the merchant's bank 270). When the payment provider system 700 determines that the customer 220 is properly registered with the remote payment processing system (i.e., when a match is found between the received mobile device identifier and the stored mobile device identifier 750), the payment provider system 700 uses the stored payment account information 724 associated with the mobile device identifier 750, along with the merchant information and transaction information to coordinate a fund transfer from the customer's bank 260 to the merchant's bank 270 in an amount equal to the total purchase price. The total purchase price will include local tax when applicable and may be further adjusted by any customer discounts.

The payment provider system 700 can communicate directly with each of the customer's bank 260 and the merchant's bank 270 to settle the respective customer payment and merchant accounts. In an optional alternative embodiment, the payment provider system 700 forwards all payment transaction information through a clearing house 250. Upon completion of the instruction directing the transfer, the payment provider system 700 sends a confirmation message to the merchant by way of the point of sale device 240. The confirmation message confirms that the payment has been authorized. Upon receipt of the confirmation message, the point of sale device 240 can print a sales receipt for the customer.

FIG. 2B is a functional block diagram illustrating an alternative embodiment of a purchaser to merchant payment where a unique token is communicated from a pre-configured mobile device to a merchant. As with the embodiment illustrated in FIG. 2A, the payment account specific information 724, personal information and the mobile device identifier 750 are communicated to the payment provider system 700 during a registration process, and stored in registration information 710 within a memory device associated with the payment provider system 700. As a result, no payment account specific information 724 or personal information of any kind need be transferred, shared or otherwise communicated at a point of sale. The payment provider system 700 is a hardware device such as a server computer that is accessible via one or data networks. The payment provider system 700 can be operated by the retailer or by a third-party service provider.

A purchaser to merchant payment is illustrated with a point of sale 200 and a payment network 205 separated from one another by various wired or wireless data networks (not shown). A pre-registered customer 220, i.e., an individual with a payment account that has been registered with the payment provider system 700 interacts with a merchant/retailer 230 or with a point of sale device 240 to identify a good or service that the customer 220 would like to purchase. In the alternative embodiment illustrated in FIG. 2B, a unique token is communicated in the form of a two-dimensional bar code 245 to the point of sale device 240. The unique token can be presented in forms other than the two-dimensional bar code. For example, other bar codes or encoded images may be used as a mechanism for communicating information from the pre-registered customer's mobile device 600 to the point of sale device 240. In preferred embodiments, the unique token is generated by the mobile device 600 and presented graphically on a display device associated with the mobile device 600. For example, the unique token may include encoded information such as the time, date, and an identifier associated with the owner of the mobile device 600. The unique token may also include a sequence number or an alphanumeric transaction identifier. In whatever form generated, the unique token is all that the registered customer 220 presents to the merchant and/or the merchant's point of sale device at the point of sale 200. That is, no customer account information or personal information is communicated at the point of sale 200.

The merchant's point of sale device 240, which includes or is communicatively coupled to a scanner capable of reading the unique token, receives the mobile device generated token and forwards the same with merchant and transaction information to a remote payment provider system 700. As indicated above, the point of sale device 240 is coupled via one or more wired or wireless networks to the remote payment provider system 700. The merchant and transaction information includes a merchant identifier, location, date, time, a description of the goods or services that the customer 220 would like to make payment for as well as tax or additional information about the merchant and the transaction. Alternatively, the merchant information may include a retail location identifier and a merchant account where payment is to be accepted. In this alternative embodiment, the transaction information may include a predetermined total amount to be transferred.

Upon receipt of the communication from the point of sale device 240 including the mobile device generated unique token, the payment provider system 700, searches previously stored registration information 710 for a matching mobile device identifier 750 or other information encoded in the token that identifies the pre-registered customer 220. The receipt of the unique token generated on the mobile device 600 and communicated by the merchant's point of sale device 240 with the merchant and transaction information authorizes the payment provider system 700 to generate an instruction that directs the transfer of a total purchase price from a first bank supporting the payment account (e.g., the customer's bank 260) to a second bank having a merchant's account (e.g., the merchant's bank 270). When the payment provider system 700 determines that the customer 220 is properly registered with the remote payment processing system (i.e., when a match is found between the received mobile device identifier 750 and the stored mobile device identifier 750), the payment provider system 700 applies one or more checks of the information encoded in the unique token before issuing one or more instructions that direct a payment transaction. The one or more checks may include verifying that the time and date encoded in the unique token are substantially the same or within a predetermined window that starts some time before the token was communicated to the payment system 700 by the point of sale device 240. For certain merchants and under certain circumstances it may be desired to permit a validity window of several minutes. For other merchants and other conditions it may be desired to permit a validity window of longer than several minutes. In addition to checking the date and time that the customer's mobile device 600 generated the unique token, the payment provider system 700 may check to verify that the sequence or transaction number (when a sequence or transaction number is provided in the token) has not been used in connection with another payment request.

Once the payment provider system 700 confirms the communicated token is unique and confirms that the mobile device identifier 750 or other information identifies a pre-registered customer 220, the payment provider system 700 uses the stored payment account information 724 associated with the pre-registered customer 220, along with the merchant information and transaction information to coordinate a transfer from the customer's bank 260 to the merchant's bank 270. The transferred funds are in an amount equal to the total purchase price. The total purchase price will include local tax when applicable and may be further adjusted by any customer discounts.

The payment provider system 700 can communicate with each of the customer's bank 260 and the merchant's bank 270 to settle the respective customer payment and merchant accounts. In an optional embodiment, the payment provider system 700 forwards all payment transaction information through a clearing house 250. Upon completion of the instruction directing the transfer, the payment provider system 700 sends a confirmation message to the merchant by way of the point of sale device 240. The confirmation message confirms that the payment has been authorized. Upon receipt of the confirmation message, the point of sale device 240 can print a sales receipt for the customer. In addition, to the confirmation message communicated to the merchant, the payment provider system 700 may send a separate confirmation message to the mobile device 600.

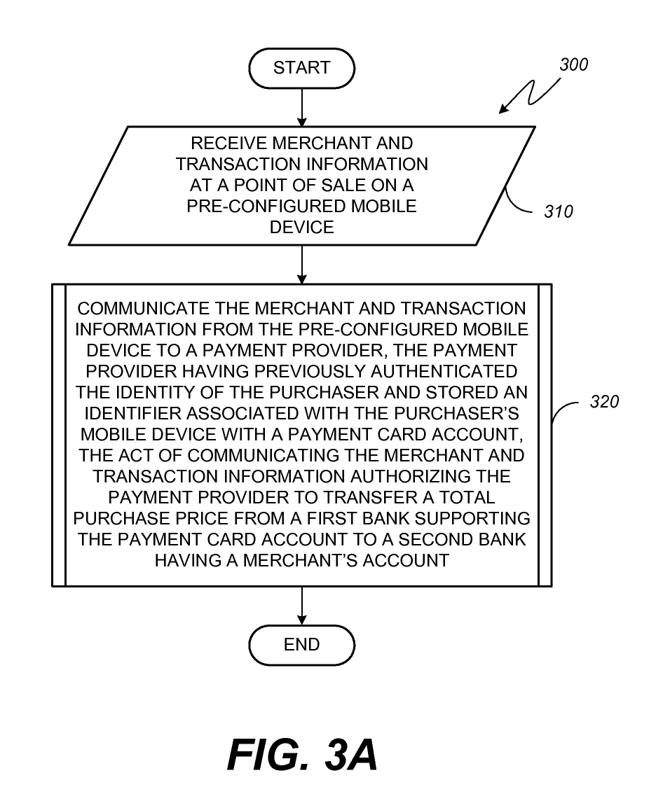

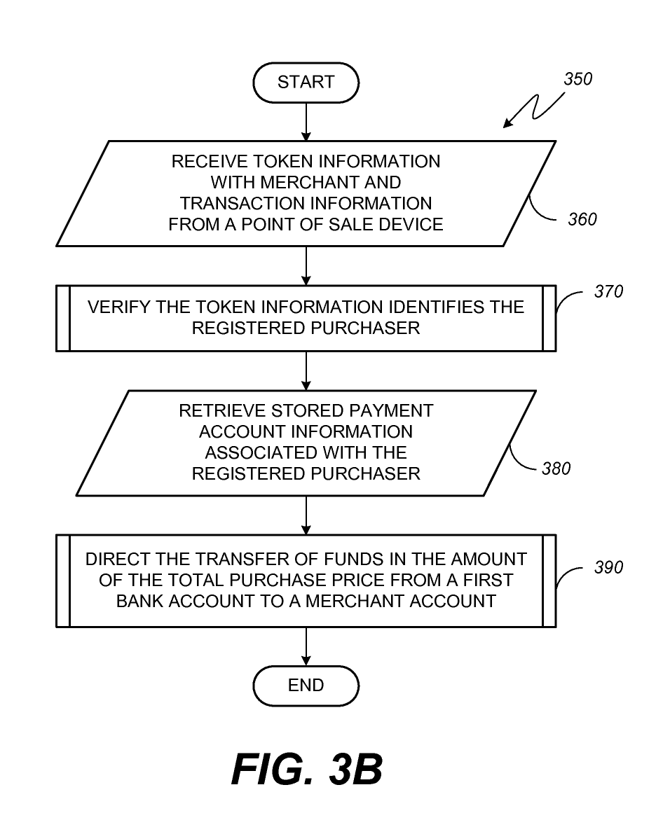

FIG. 3A is a flow diagram illustrating an embodiment of a method for processing a payment between a registered purchaser with a pre-configured mobile device and a merchant. The flow diagram in FIG. 3A describes the payment from the perspective of a customer's mobile device 600.

The method 300 begins with input/output block 310 where merchant and transaction information are received at a point of sale on a customer's pre-configured mobile device such as the mobile device 600. Thereafter, in block 320, the merchant and transaction information is communicated along with a mobile device specific identifier from the mobile device 600 to a payment provider system 700. As indicated in block 320, the payment provider system 700, during a registration process with the owner of the mobile device 600 and holder of a valid payment account, receives and stores the customer's payment account information along with any personal information and the mobile device identifier. Thereafter, the receipt of a communication from the customer's mobile device 600 that includes merchant and transaction information authorizes the payment provider system 700 to coordinate or otherwise direct the transfer of a total purchase price from a first bank supporting the payment account to a second bank supporting a merchant's account.

An alternative method 350 for processing a payment between a registered purchaser with a pre-configured mobile device 600 and a merchant 230, is illustrated in FIG. 3B. The method 350 begins with input/output block 360 where a payment provider system 700 receives token information along with merchant and transaction information from a point of sale device 240. In block 370, the token information is used to identify and verify that the token was received from a registered purchaser. Thereafter, as shown in input/output block 380, the payment provider system 700 retrieves stored payment account information associated with the registered purchaser. Next, as shown in block 390, the payment provider system 700 directs the transfer of funds in the amount of the total purchase price from a first bank account supporting the payment account to a second bank account supporting a merchant bank account.

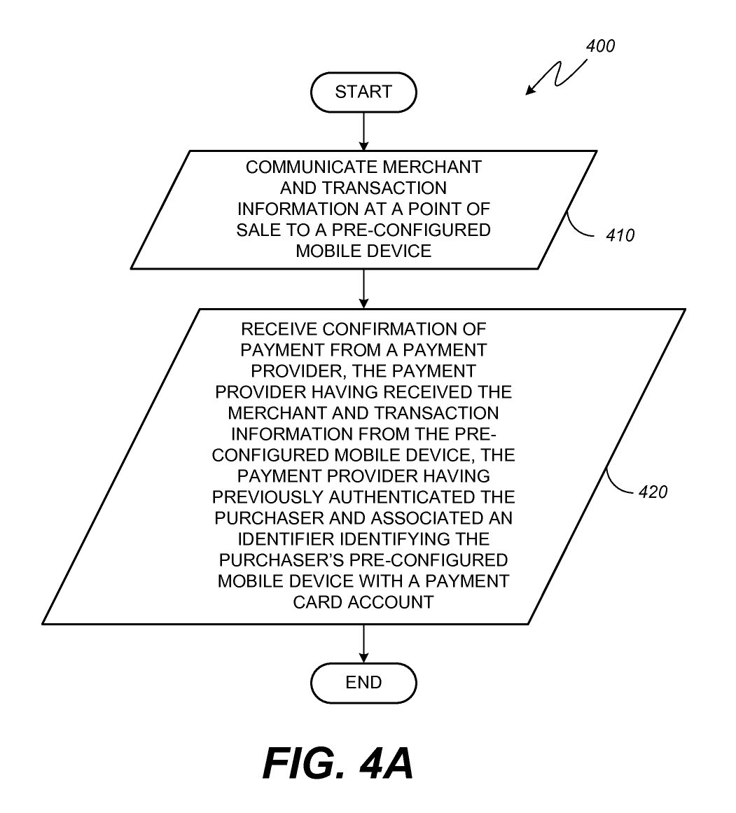

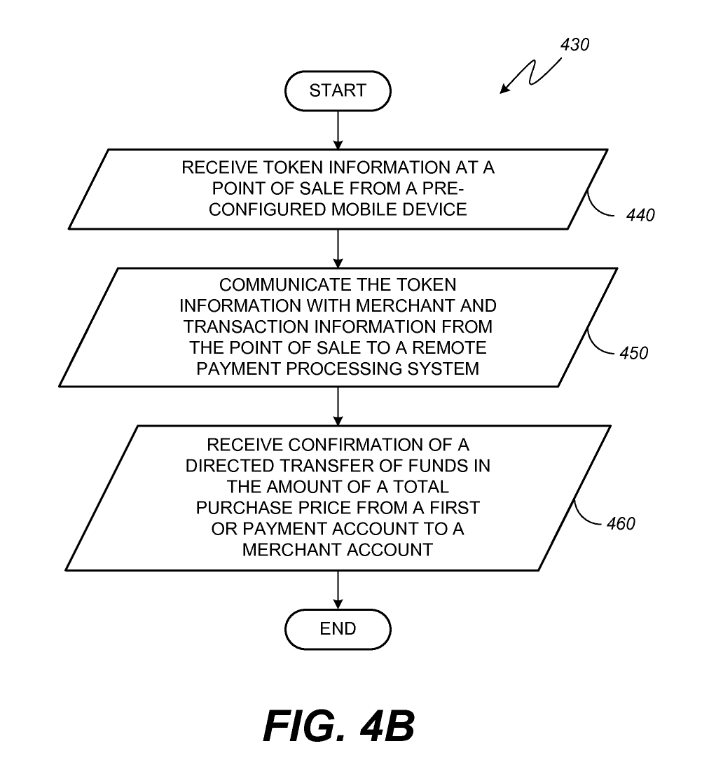

FIG. 4A is a flow diagram illustrating an embodiment of a method 400 for conducting a sale of goods or services to a pre-registered purchaser with a pre-configured mobile device. A pre-configured mobile device such as the mobile device 600 is a portable communication device with a software application that when executed by the mobile device 600 communicates the merchant and transaction information along with a mobile device specific identifier such as a phone number, a serial number, etc., to the payment provider system 700. The flow diagram in FIG. 4 describes the sale of goods or services from the perspective of a merchant's point of sale device 240.

The method 400 begins with input/output block 410 where merchant and transaction information are communicated at a point of sale to a customer's pre-configured mobile device, such as the mobile device 600. In an embodiment, the merchant and transaction information are communicated in a two-dimensional code 245 that is generated and presented by a point of sale device 240. In an alternative embodiment, merchant information and a total purchase amount (including local sales taxes to be collected by the retailer) are communicated directly from the point-of-sale device to a remote payment provider system 700. Upon completion of the generation of an instruction authorizing the transfer of funds in the amount of a total purchase price from a first bank supporting the payment account to a second bank supporting a merchant's account and as indicated in input/output block 420, the point of sale device 240 receives confirmation of payment from the remote payment provider system 700. As further indicated in input/output block 420, the payment provider system 700 receives merchant and transaction information along with a mobile device specific identifier from the point of sale. The remote payment provider system 700, during a registration process with the owner of the mobile device 600 and holder of a valid payment account, authenticates the identity of the payment card holder and receives and stores the customer's payment account information along with any personal information and the mobile device identifier. Thereafter, the receipt of a communication from the customer's mobile device 600 authorizes the remote payment provider system 700 to coordinate the payment in accordance with the merchant and transaction information and the previously stored and authenticated payment account information.

An alternative method 430 for conducting a sale of goods or services to a pre-registered purchaser with a pre-configured mobile device is illustrated in FIG. 4B. The method 430 begins with input/output block 440 where a point of sale device 240 receives token information along with merchant and transaction information. In input/output block 450, the merchant communicates the token information with merchant and transaction information from the point of sale to a remote payment provider system 700. Thereafter, as shown in input/output block 460, the merchant receives confirmation of a directed transfer of funds in the amount of the total purchase price from a first bank account supporting the payment account to a second bank account supporting a merchant bank account.

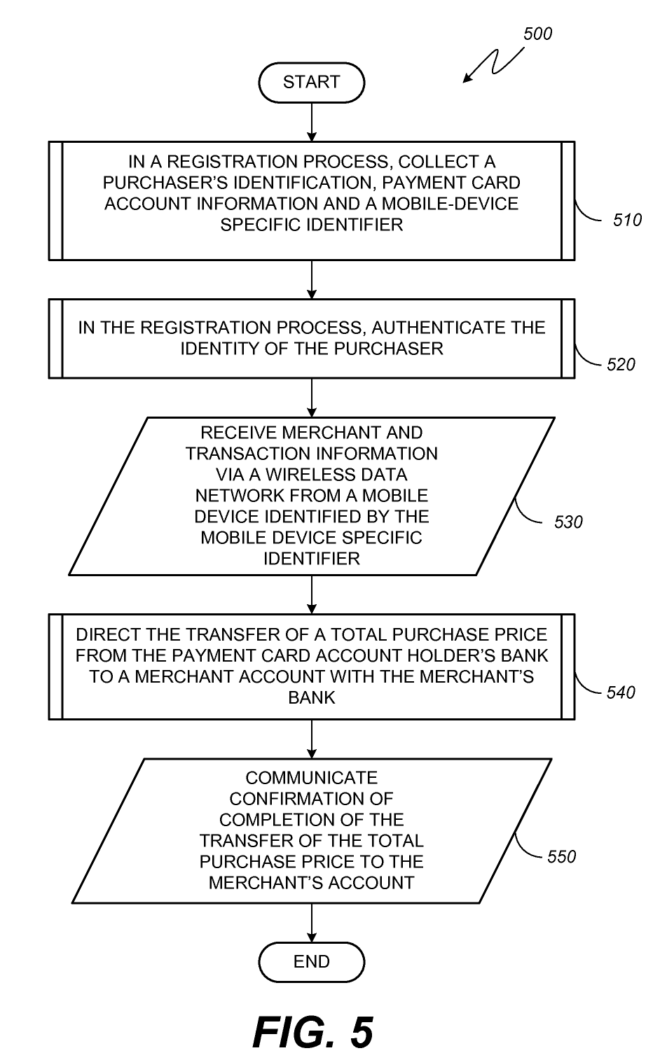

FIG. 5 is a flow diagram illustrating an embodiment of a method for processing a payment between a payment account holder's bank and a merchant's bank. The flow diagram in FIG. 5 describes the payment from the perspective of a payment provider service or payment provider system 700.

The method 500 begins with a registration process which is described in association with block 510 and block 520. In block 510, a payment provider service or payment provider system 700 collects information including the identity of a payment account holder, payment account information and a mobile device specific identifier. In block 520, the payment provider service or payment provider system 700 authenticates the identity of the payment account holder and the payment account information. Thereafter, as shown in input/output block 530, the payment provider service or payment provider system 700 receives merchant and transaction information via a wireless data network 250 from a mobile device 600 identified by a mobile device specific identifier. In response, as illustrated in block 540, the payment provider service or payment provider system 700 directs the transfer of a total purchase price from the payment account holder's bank to a merchant's bank. In association with the transfer, the payment account holder's account will be debited by the purchase amount. Upon completion of a communication including the instruction to a network, financial institution or an alternative payment service and as indicated in input/output block 550, the payment provider service or payment provider system 700 communicates confirmation of the same to the point of sale device 240 and to the mobile device 600.

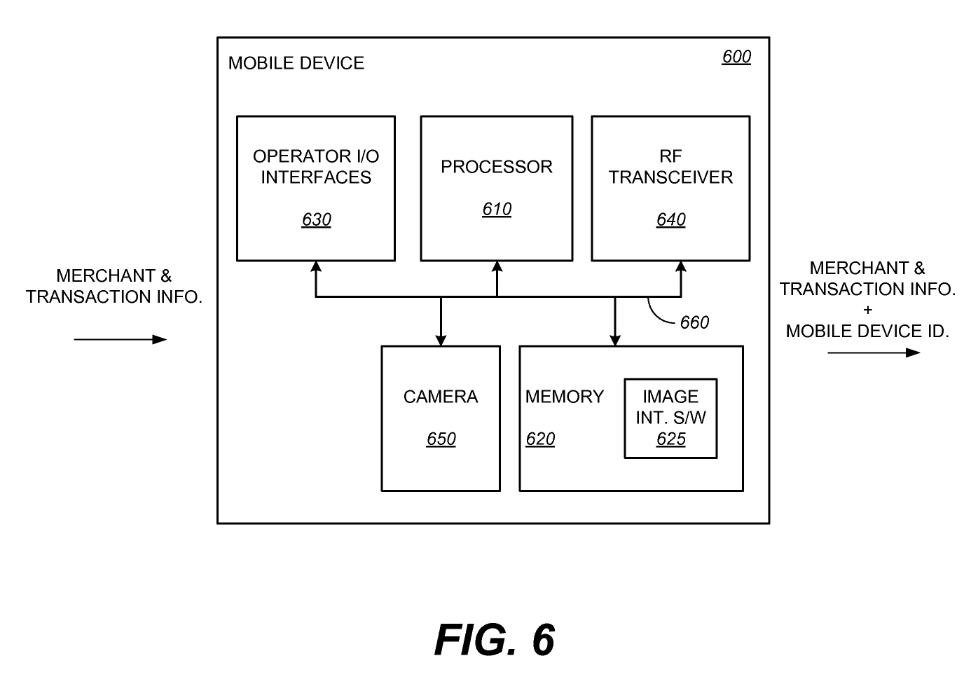

FIG. 6 is a functional block diagram of the mobile device 600 of FIG. 2. As shown in FIG. 6, the mobile device 600 receives merchant and transaction information and communicates the merchant and transaction information along with a mobile device identifier via a wireless data network 250 (FIG. 2).

The mobile device 600 includes a processor 610, a memory element 620, operator input/output (I/O) interfaces 630, a radio frequency (RF) transceiver 640, and a camera 650, in communication with one another or coupled together by way of a local bus 670. The operator I/O interfaces 630 represent any interface with which a user, such as the customer 220, may interact with the mobile device 600. For example, the operator I/O interfaces 630 may include a speaker, a display, a keyboard, a microphone, a trackball, a thumbwheel, or any other user-interface element. A power source 660, which may be a direct current (DC) battery or other power source, is also connected to the local bus 670 to provide power to the mobile device 600. In a particular embodiment, the mobile device 600 can be, for example but not limited to, a portable telecommunication device such as a mobile cellular-type telephone.

The processor 610 and the memory element 620 provide the signal timing, processing and storage functions for the mobile device 600. The processor 610, working in conjunction with parameters and executable software stored in the memory element 620, provides data and control signals to and receives data from the RF transceiver 640. The RF transceiver 640 receives data from remote transmitters and forwards the received data to the processor 610 for further processing. The RF transceiver 640 includes a transmitter, a receiver, a power amplifier, and a power amplifier controller (all not shown) that enable radio communications to and from the mobile device 600.

The camera 650, which operates under the control of the processor 610 and one or more application programs stored in the memory element 620, is an image capture system capable of recording an image of the two-dimensional code 245. In an embodiment, the two-dimensional code is communicated in its received condition (i.e., without decoding) to the payment provider system 700 (FIG. 2). In an alternative embodiment, the two-dimensional code is decoded by the processor 610, which is executing the image interpretation software 625 stored in the memory element 620.

Depending on the manner in which the camera 650 and methods for communicating the merchant and transaction information from the mobile device 600 are implemented, the mobile device 600 may also include one or more of an application-specific integrated circuit (ASIC), a field programmable gate array (FPGA), or any other implementation-specific or general processor.

The local bus 660, although shown as a single bus, may be implemented using multiple busses connected as necessary among the various subsystems within the mobile device 600.

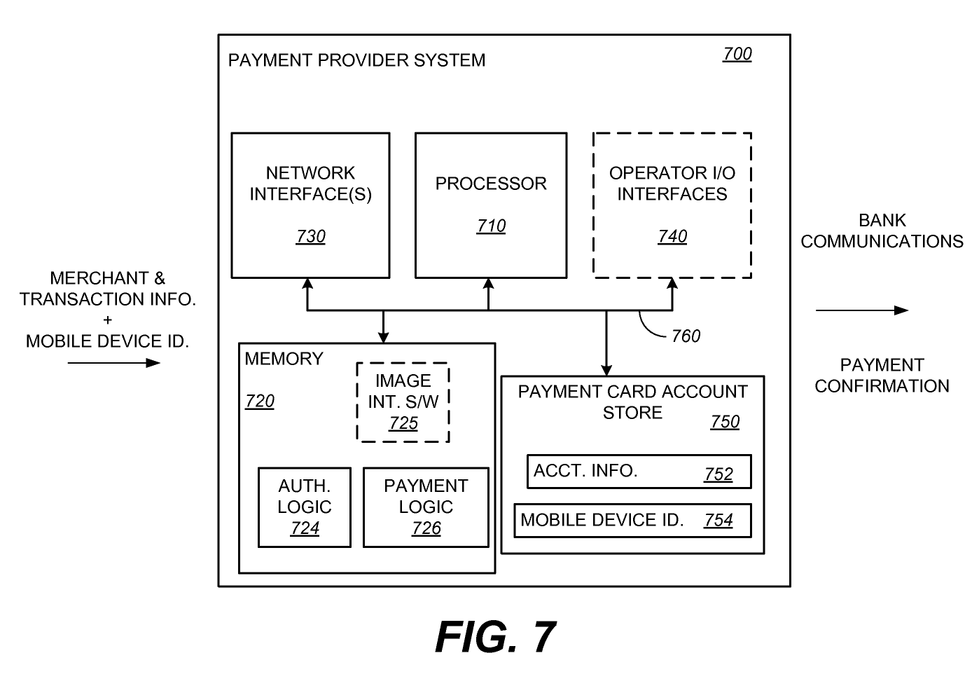

FIG. 7 is a functional block diagram of the payment provider system 700 of FIG. 2. The payment provider system 700, which may be implemented on a network-coupled computing device, includes a processor 710, a memory element 720, one or more network interfaces 730, optional operator I/O interfaces 740, and a payment account store 750. The payment provider system 700 responds to communications received via a data network that contain merchant information, transaction information and a mobile device identifier in one or more communications. In accordance with authentication and payment logic stored in the memory element 720 and account information 752 and a mobile device identifier 754 stored in the payment account store 750, the payment provider system 700 interacts via bank communications and a payment instruction confirmation message with network-coupled remote devices (e.g., point-of-sale devices and mobile devices).

Generally, in terms of hardware architecture, the payment provider system 700 is a general purpose computing device, a server computer or other hardware device that includes the processor 710, memory 720, network interfaces 730, optional operator input/output (I/O) interface(s) 740 and the payment account store 750, each of which is coupled to the other elements via a local interface 760. The local interface 760 can be, for example but not limited to, one or more buses or other wired or wireless connections, as is known in the art. The local interface 760 may have additional elements, which are omitted for simplicity, such as controllers, buffers (caches), drivers, repeaters, and receivers, to enable communications. Further, the local interface 760 may include address, control, power and/or data connections to enable appropriate communications among the aforementioned components. Moreover, the local interface 760 provides power to each of the processor 710, memory 720, network interfaces 730, operator I/O interface(s) 740 and the payment account store 750 in a manner understood by one of ordinary skill in the art.

The processor 710 is a hardware device for executing software (i.e., programs or sets of executable instructions), particularly those stored in the memory element 720. The processor 710 can be any custom made or commercially available processor, a central processing unit (CPU), an auxiliary processor among several processors associated with the payment provider system 700, a semiconductor based microprocessor (in the form of a microchip or chip set), or generally any device for executing instructions.

The memory 720 can include any one or combination of volatile memory elements (e.g., random-access memory (RAM), such as dynamic random-access memory (DRAM), static random-access memory (SRAM), synchronous dynamic random-access memory (SDRAM), etc.) and nonvolatile memory elements (e.g., read-only memory (ROM), hard drive, tape, compact disk read-only memory (CD-ROM), etc.). Moreover, the memory 720 may incorporate electronic, magnetic, optical, and/or other types of storage media. Note that the memory 720 can have a distributed architecture, where various components are situated remote from one another, but can be accessed by the processor 710 via the local interface 740.

The software in the memory 720 may include one or more separate programs, each of which comprises an ordered listing of executable instructions for implementing logical functions. In the example embodiment illustrated in FIG. 7, the software in the memory 720 includes authentication logic 724, image interpretation software 725, and payment logic 726. FIG. 7 illustrates an integrated payment provider system 700 in which the above-described programs may be employed. In alternative embodiments, one or more of the authentication logic 724, the image interpretation software 725, and the payment logic 726 may be implemented via one or more distributed computing devices remote from but accessible to the payment provider system 700.

The network interfaces 730 can be implemented by wired or wireless data communication mechanisms that transfer information between connected devices using one or more data transfer protocols. The optional operator interfaces 740, illustrated with a dashed line, may include for example a microphone, a speaker, a keyboard, pushbuttons, a graphical user interface and/or combinations of these input/output devices.

In operation, the payment provider system 700 performs a pre-registration process where a potential customer of a payment service contacts the payment provider system 700 and communicates their payment account information 752, a mobile device identifier 754 and any additional personal information required by the retailer. The pre-registration procedure may be accomplished via a telephone call to the retailer or electronically via the Internet via secured on-line interfaces suitable for the communication of personal and payment account information over networks. This information is associated in the payment account store 750. As part of the pre-registration process, the authentication logic 724 is executed to perform a process whereby the potential customer's identity is confirmed or authenticated to ensure to the satisfaction of the payment provider system 700 that the potential customer is an authorized user of the identified payment account(s).

Once the pre-registration, including the authentication procedure is complete, the payment provider system 700 waits to process requests to make secure payments. Such requests are initiated by the mobile device 600 and communicated to the payment provider system 700 via one or more wireless and wired networks. The requests will include merchant information and transaction information along with a mobile device identifier, such as a phone number or serial number. When the received mobile device identifier matches a previously registered mobile device identifier such as the mobile device identifier 754, the payment provider system 700 executes the payment logic 726 stored in the memory element 720 to complete a secured payment. The payment logic 726 generates the required communications to the customer's bank and the merchant's bank that identify the purchase transaction and the transfer of funds in the amount of the total purchase price from the customer's bank to the merchant's account. Upon completion and communication of the instruction directing the secured fund transfer, the payment provider system 700 generates a confirmation message that is communicated to the merchant identified in the merchant information received in the payment request and to the customer via their mobile device 600. Upon receipt of the confirmation, the merchant can print a sales receipt and release the goods to the customer 220 or perform the agreed upon service for the customer 220.

The above-described apparatus, system, and methods for purchaser to merchant payments may be embodied in conjunction with any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any mechanism that can contain, store, communicate, propagate, or transport the program for use by or in connection with the instruction execution system, apparatus, or device.

While various embodiments of the purchaser to merchant payments have been described, it will be apparent to those of ordinary skill in the art that many more embodiments and implementations are possible that are within the scope of the disclosed apparatus, system and methods. The illustrated and described embodiments of purchaser to merchant payments are not limited to a specific type of mobile device, a specific network or a specific payment account type.

What is claimed is:

1. A method for processing a payment between a registered purchaser with a pre-configured mobile device and a merchant, the method comprising:
receiving merchant and transaction information at a point of sale on the pre-configured mobile device; and
communicating the merchant and transaction information from the pre-configured mobile device to a remote payment processing system, the remote payment processing system having previously authenticated the identity of the purchaser and having associated an identifier associated with the purchaser's mobile device with a payment account, wherein the act of communicating the merchant and transaction information from the pre-configured mobile device authorizes the remote payment processing system to transfer a total purchase price from a first bank supporting the payment account to a second bank having a merchant's account.

2. The method of claim 1, wherein receiving merchant and transaction information at a point of sale on the pre-configured mobile device comprises capturing an image of a two-dimensional code having the merchant and transaction information encoded therein.

3. The method of claim 1, wherein communicating the merchant and transaction information from the pre-configured mobile device to a remote payment processing system comprises sending a message on a wireless data network.

4. The method of claim 1, wherein the identifier comprises a cellular telephone number.

5. A method for conducting a sale of goods or services to a pre-registered purchaser with a pre-configured mobile device, the method comprising:
communicating merchant and transaction information at a point of sale to the pre-configured mobile device; and
receiving confirmation of payment from a remote payment processing system, the remote payment processing system having received the merchant and transaction information from the pre-configured mobile device, the remote payment processing system having previously authenticated the identity of the purchaser and associated an identifier associated with the purchaser's mobile device with a payment account, wherein a communication of the merchant and transaction information from the pre-configured mobile device authorizes the remote payment processing system to transfer a total purchase price from a first bank supporting the payment account to a second bank having a merchant's account.

6. The method of claim 5, wherein communicating merchant and transaction information at a point of sale to the pre-configured mobile device comprises generating and presenting a two-dimensional code having at least a merchant identifier and a transaction identifier encoded therein.

7. The method of claim 6, wherein receiving confirmation of payment from a remote payment processing system comprises receiving a message on a data network, the message including at least the transaction identifier.

8. A method for processing a payment between a payment account holder's bank and a merchant's bank, the method comprising:
in a registration process,
collecting a purchaser's identification information, payment account information and at least one mobile device specific identifier; and
authenticating the identity of the purchaser;
in a commercial transaction,
receiving merchant and transaction information via a wireless data network from a mobile device associated with the at least one mobile device specific identifier, wherein receipt of the merchant and transaction information from the mobile device directs the remote payment processing system to transfer a total purchase price from the payment account holder's bank to a merchant's account with the merchant's bank; and
communicating confirmation of completion of the transfer of the total purchase price to the merchant.

9. The method of claim 8, wherein the registration process further comprises storing the purchaser's identification information, payment account information and the at least one mobile device specific identifier in a payment card industry data security standard compliant computing device coupled to one or more data networks.

10. The method of claim 8, wherein the at least one mobile device specific identifier is a phone number.

11. The method of claim 8, wherein receiving merchant and transaction information via a wireless data network from a mobile device associated with the at least one mobile device specific identifier comprises receiving a two-dimensional code.

12. The method of claim 8, wherein receiving merchant and transaction information via a wireless data network from a mobile device associated with the at least one mobile device specific identifier comprises receiving one of a merchant identifier, a description of a good or service, a quantity, a purchase price per item, a subtotal, a tax indicator, and a total purchase price.

13. The method of claim 12, wherein the merchant identifier, description of the good or service, quantity, purchase price per item, subtotal, tax indicator, and total purchase price are decoded on the mobile device.

14. The method of claim 8, wherein communicating confirmation of completion of the transfer of the total purchase price to the merchant comprises sending a message via a data network to a merchant point of sale device, the message including at least a portion of the transaction information.

15. A device, comprising:
a mechanism for capturing merchant and transaction information at a point of sale; and
a transmitter for communicating the merchant and transaction information from the mobile device to a remote payment processing system, the remote payment processing system having previously authenticated the identity of the purchaser and associated an identifier associated with an identified mobile device with a payment account, wherein the act of communicating the merchant and transaction information from the mobile device authorizes the remote payment processing system to transfer a total purchase price from a first bank supporting the payment account to a second bank having a merchant's account.

16. The device of claim 15, wherein the mechanism comprises a camera.

17. The device of claim 16, wherein the camera captures an image of a two-dimensional code having the merchant and transaction information encoded therein.

18. The device of claim 15, wherein the identifier associated with the identified mobile device comprises a phone number.

19. A network-based system, comprising:
a network interface configured to receive payment account and personal information from a holder of a payment card, the personal information including a mobile device specific identifier, the network interface further configured to receive merchant and transaction information from a mobile device associated with the mobile device specific identifier;
a memory in communication with the network interface, the memory for storing the mobile device specific identifier, the payment account and personal information from the holder of the payment card, executable authentication logic, and executable payment logic; and
a processor in communication with the network interface and the memory, the processor configured to execute the executable authentication logic to authenticate the identity of the holder before enabling the executable payment logic.

20. The system of claim 19, wherein the mobile device specific identifier comprises a phone number.

21. A method for processing a payment between a registered purchaser with a pre-configured mobile device and a merchant, the method comprising:
receiving token information with merchant and transaction information at a remote payment processing system, the transaction information identifying a total purchase price;
verifying that the token information identifies the registered purchaser;
retrieving previously stored payment account information associated with the registered purchaser; and
directing the transfer of funds in the amount of the total purchase price from a first bank account supporting the payment account to a second bank account having a merchant's account.

22. A method for conducting a sale of goods or services to a pre-registered purchaser with a pre-configured mobile device, the method comprising:
receiving token information at a point of sale from the pre-configured mobile device;
communicating the token information with merchant and transaction information from the point of sale to a remote payment provider system; and
receiving confirmation from the remote payment provider system of a directed transfer of funds in the amount of a total purchase price from a payment account to a merchant's account, the remote payment processing system having previously authenticated the identity of the pre-registered purchaser and associated the pre-registered purchaser with the payment account.
